(19) United States
(12) Patent Application Publication
(10) Pub. No.: US 2019/0033603 A1
(43) Pub. Date: Jan. 31, 2019

(54) LIGHTING STAND TYPE MULTIMEDIA DEVICE

(71) Applicant: Kornic Automation Co., Ltd, Hwaseong-si (KR)

(72) Inventor: Shin Hwan HWANG, Seoul (KR)

(73) Assignee: Kornic Automation Co., Ltd

(21) Appl. No.: 16/048,211

(22) Filed: Jul. 27, 2018

(30) Foreign Application Priority Data
Jul. 31, 2017 (KR) 10-2017-0097051

(51) Int. Cl. G02B 27/02; G06K 9/00; G06F 3/01; G06F 17/30; G09B 5/06

(52) U.S. Cl. CPC G02B 27/026; G06K 9/00335; G06Q 50/205; G06F 17/30256; G09B 5/06; G06F 3/015

(57) ABSTRACT

Disclosed herein is a lighting stand type multimedia device. The multimedia device according to one embodiment includes a main body having a base, a support, and a header, a projection part, a first camera, a second camera, a communication part, an audio input part, an audio output part, an actuator, and a controller. The multimedia device may identify a different object placed on a table and project on image of information about the object on the table, or may provide simple light. In addition, the multimedia device may track movement of sight of a user using the cameras, identify an object of the tracked sight position, and project an image of information about the object or provide necessary light to a sight position.

### CROSS-REFERENCE TO RELATED APPLICATION

This application claims priority to and the benefit of Korean Patent Application No. 10-2017-0097051, filed on Jul. 31, 2017, the disclosure of which is incorporated herein by reference in its entirety.

### BACKGROUND

### 1. Field of the Invention

The present invention relates to a small home appliance, and more particularly, to a lighting stand type multimedia device to be placed on a desk.

### 2. Discussion of Related Art

Since electronic devices are miniaturized and intellectualized by the development of electronic fields, the conventional electronic devices having one function have been recently combined, thereby increasing electronic devices having various functions.

Consumers are interested in the electronic devices and demands for the electronic devices have also increased.

Korean Laid-open Patent No. 10-2015-0120198 discloses an intelligent lighting device. The lighting device may serve a lighting function and may also serve as an image projector.

Particularly, when an event occurs at an external electronic device such as a smartphone, the lighting device receives an image signal and a sound signal, which correspond to the event, and outputs an image and a sound through a beam projector instead of providing lighting.

### SUMMARY OF THE INVENTION

The present invention is directed to providing an intelligent multimedia device capable of identifying an object and providing information about the object.

The present invention is also directed to providing an intelligent multimedia device configured to identify characters printed on an object and provide information about the characters.

The present invention is also directed to providing an intelligent multimedia device configured to track a sight direction of a user to identify an object positioned in the sight direction and provide information about the object.

The present invention is also directed to providing an intelligent multimedia device capable of helping with learning in conjunction with a learning activity.

According to an aspect of the present invention, there is provided a lighting stand type multimedia device including a main body, a projection part, a first camera, and a controller. The main body includes a base, a support fixed to the base, and a header fixed to an upper portion of the support. The projection part is installed in the header of the main body, and the first camera is installed in the main body. The controller is position inside the main body and includes a lighting provider, an object identifier, and an additional information provider. The lighting provider provides light through the projection part, the object identifier specifies and identifies an object of interest captured by the first camera, and the projection part projects an image of additional information about the object of interest

According to another aspect, the multimedia device may further include a second camera. In addition, the controller may further include a sightline identifier. The sightline identifier may track a sight direction of the user by using the first camera and the second camera.

According to another aspect, the additional information provider may provide additional information about an object to a position derived from a position of the object.

According to another aspect, the additional information provider may provide additional information about an object to a position derived from a sight position.

According to another aspect, the multimedia device may further include a communication part. Here, the additional information may include information obtained by browsing the Internet.

According to another aspect, an object identified by the object identifier may include information printed on the object.

According to another aspect, the lighting provider may control an output of the projection part to provide light for a sight position.

According to another aspect, the controller may further include an action interface. Here, the action interface may receive an image, analyze an action of a user to identify whether the action is a control command, and perform a set corresponding function according to a result of the identification.

According to another aspect, the multimedia device may further include an audio input part. In addition, the controller may further include a voice interface. The voice interface may receive a voice from the audio input part, analyze the voice to identify the voice is a control command, and perform a set corresponding function according to a result of the identification.

According to another aspect, the controller may further include a learning manager. Here, when an identified object is identified as a learning material, the learning manager may perform learning management including time management and progress management related to the learning material.

According to another aspect, the learning manager may identify a learning attitude of the user, and check and manage a concentration level according to a learning progress whiling performing the learning management.

According to another aspect, the multimedia device may include an audio output part. In addition, the controller may include a distance learning part. Here, the distance learning part may receive customized learning contents from a distance server according to contents and a progress of the learning material to provide the customized learning contents to a position derived from a position of the learning material.

According to another aspect, the distance learning part may bidirectionally communicate with a distance teacher to provide a distance learning.

According to another aspect, the main body may further include a three-axial actuator installed at one position at which the base is connected to the support or the support is connected to the header and configured to rotate in three axial directions, and the controller may further include an actuator controller configured to control the three-axial actuator according to a position derived from a position of an identified object of interest.

According to another aspect, the main body may further include a three-axial actuator installed at one position at which the base is connected to the support or the support is connected to the header and configured to rotate in three axial directions, and the controller may further include an actuator controller configured to control the three-axial actuator according to a position derived from a tracked sight position.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a lighting stand type multimedia device according to one embodiment;

FIG. 2 is a block diagram illustrating a functional configuration of the multimedia device according to one embodiment;

FIG. 3 is a flowchart illustrating a learning management process of a multimedia device according to another embodiment;

FIG. 4 is a flowchart illustrating a learning concentration management process of the multimedia device according to another embodiment;

FIG. 5 is a brief conceptual view about a distance learning function of the multimedia device according to another embodiment;

FIG. 6 is a brief conceptual view about a bidirectional distance learning function of the multimedia device according to another embodiment; and

FIG. 7 is a brief conceptual view related to an actuator (170) of the multimedia device according to another aspect.

### DETAILED DESCRIPTION OF EXEMPLARY EMBODIMENTS

The above-described and additional aspects of the present invention will be realized from embodiments described with reference to the accompanying drawings. It is understood that components in the embodiments may be variously combined in one embodiment as long as there are no mentions thereabout and confliction therebetween. Although a block of a block diagram may denote physical components in some cases, the block may denote a partial function of one physical component or may logically denote a function performed by a plurality of components in other cases. In some cases, substances of a block or a part of the block may be a set of program commands. Some or all of the blocks may be realized by hardware, software, or a combination thereof.

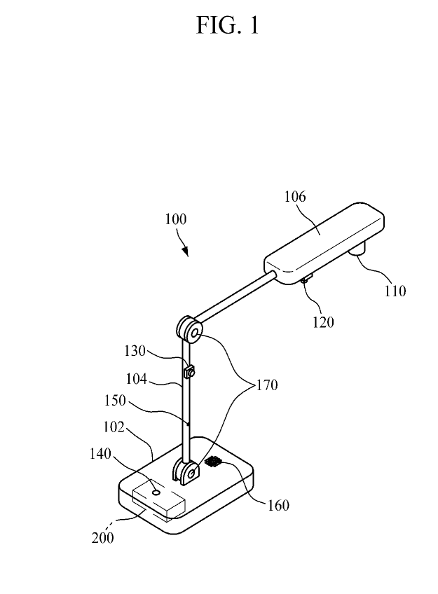

FIG. 1 is a perspective view illustrating a lighting stand type multimedia device according to one embodiment.

The multimedia device according to one aspect includes a main body 100, a projection part 110, a first camera 120, and a controller 200.

The main body 100 includes a base 102, a support 104 fixed to the base 102, a header 106 fixed to an upper portion of the support 104.

The projection part 110 is installed on the header 106 of the main body 100, and the first camera 120 is installed on the main body 100, for example, at one side of the projection part 110 of the header 106. However, the first camera 120 is not limited thereto, and is preferably installed at a position from which the first camera 120 may easily capture an image of an object on a table on which the multimedia device is placed.

The controller 200 is installed inside the main body 100, for example, inside the header 106 or inside the base 102, and specifically identifies an object of interest among objects captured by the first camera 120, and provides additional information about the object of interest through the projection part 110.

According to an additional aspect, the multimedia device may further include a second camera 130. The second camera 130 may be installed on an upper portion of the main body 100, for example, on an upper portion of the support 104.

However, the second camera 130 is not limited thereto, and the second camera 130 is preferably installed at a position from which the second camera 130 may easily capture a user and an action of the user. Particularly, a position of the second camera 130 may be determined based on the second camera 130 which tracks movement of sight of the user with the first camera 120.

The second camera 130 may track and identify a sight direction of the user with the first camera 120.

According to an additional aspect, the multimedia device may further include a communication part 140. The communication part 140 may be installed inside the main body 100, for example, inside the base 102 or header 106. The communication part 140 may communicate through a network.

According to an additional aspect, the multimedia device may further include an audio input part 150. The audio input part 150 may be installed inside the main body 100, for example, inside the support 104 or the base 102. The audio input part 150 may receive and process a sound of the user.

According to an additional aspect, the multimedia device may further include an audio output part 160. The audio output part 160 may be an embedded audio output part installed in the main body 100 or an external audio output part connected through Bluetooth. The audio output part 160 outputs audio contents.

According to an additional aspect, the multimedia device may further include three-axial actuators 170. The three-axial actuator 170 may be installed at least one portion between a portion at which the base 102 is connected to the support 104 and a portion at which the support 104 is connected to the header 106. The three-axial actuators 170 are driven in three axle directions, and controlled to move the header 106 according to a sight position.

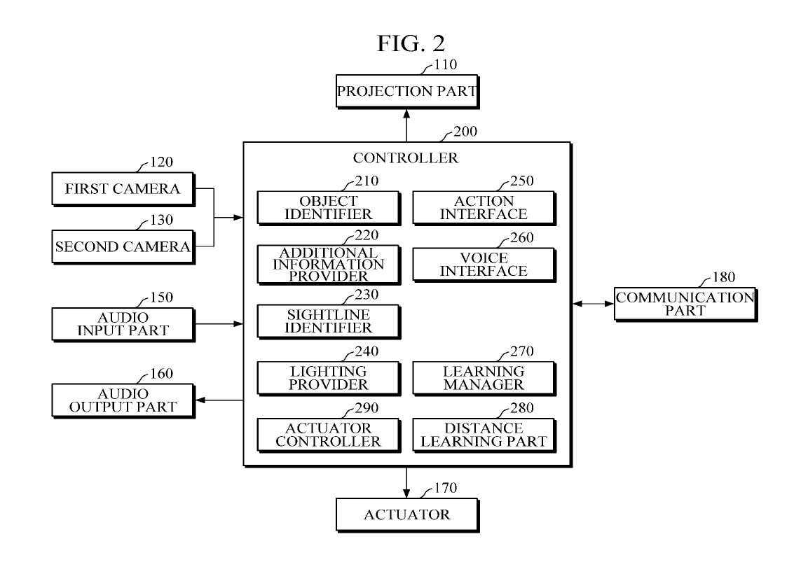

FIG. 2 is a block diagram illustrating a functional configuration of the multimedia device according to one embodiment.

According to one aspect, the multimedia device includes the main body 100, the projection part 110, the first camera 120, and the controller 200. The controller 200 includes a lighting provider 240, an object identifier 210, and an additional information provider 220.

The projection part 110 is controlled by the controller 200 to project an image on a table. The projection part 110 is used as a lighting part when there are no projection target images. A pico projector which is a small beam projector may be used as the projection part 110 in consideration of a mechanical property in which the projection part 110 is installed in the header 106 of the main body 100.

The first camera 120 captures images of objects placed on a table and transmits the images to an input of the controller 200. That is, the first camera 120 captures objects, such as, hands of the user, books place on the table, contents written in the books, and transmits the images to the input of the controller 200.

The first camera 120 may be installed in a type of camera module. A camera module may mainly include an image sensor, a lens module, an infrared (IR) filter, and the like. The image sensor is a component which receives light, that is, an image and converts the image into an electric signal, and is classified as a charge coupled device (CCD) sensor and a complementary metal oxide semi-conductor (CMOS) sensor according to operation and manufacturing methods.

The lens module transmits an image of a subject to a sensor. That is, the lens module collects or emits light emitted from the subject to form an optical image and transmits the image to the sensor.

The IR filter blocks an infrared light component included in an image signal to block an image noise generated in the sensor.

The controller 200 may include a board type control device including a processor, a memory, and the like. However the controller 200 is not limited thereto.

Each of the object identifier 210 and the additional information provider 220 may be a set of program commands stored in a memory and may be executed by a processor. However, the object identifier 210 and the additional information provider 220 are not limited thereto, and may also include specific logics, gate arrays, or combinations thereof.

The object identifier 210 specifies and identifies an object of interest among various objects which are placed on the table and captured by the first camera 120. Here, a method of specifying an object of interest may be a method in which the user points at an object with a finger, a method in which the user touches an object, or a method in which an object which is closest to the first camera 120 is specified. However, the method is not limited thereto.

The additional information provider 220 projects and provides an image of additional information about an identified object of interest through the projection part 110. For example, in a case in which an object of interest identified by the object identifier 210 is a book, the additional information provider 220 projects an image of additional information about reading start time, reading period, last reading date, and the like through the projection part 110. The lighting provider 240 controls an output of the projection part 110 to provide light. That is, the projection part 110 is a controllable lighting part capable of controlling brightness and a position without a separate lamp. Here, the multimedia device may only be used as a lighting device which does not provide additional information, or may be used as a lighting device while a part of an output of the lighting device, that is, a partial area, is used for displaying information and the remaining part thereof is used for providing light.

The lighting provider 240 may be a program command set stored in a memory and may be executed by a processor. However, the lighting provider 240 is not limited thereto, and may also include a specific logic, a gate array, or combinations thereof.

When the multimedia device according to one aspect is turned on, first, the lighting provider 240 controls an output of the projection part 110 to provide light. The first camera 120 captures images at a lit position, and the object identifier 210 specifies an object of interest among objects in the captured images. The object identifier 210 identifies the specified object of interest and transmits identified information to the additional information provider 220. The additional information provider 220 searches for additional information about the identified object and controls the projection part 110 to project and provide the additional information.

According to another aspect, the additional information provider 220 may provide additional information about an identified object of interest at a position derived from a position of the object of interest. That is, the additional information provider 220 determines a position to which the projection part 110 projects additional information in consideration of a size and a position of the identified object of interest. A method of determining the position may be a method in which an area which is a widest area around an object of interest is determined as the position, a method in which an area placed in a specific direction with respect to an object of interest is determined as the position, or the like. For example, when an object of interest is placed on the right of an area captured by the first camera 120, a left area of the object of interest may be determined as a position to which additional information is projected.

According to another aspect, an object of interest specified and identified by the object identifier 210 may be information printed on an object. For example, when an object of interest is a book and information printed on the book is a name of a specific person, an image showing additional information about the person may be projected.

According to an additional aspect, the multimedia device may include the main body 100, the projection part 110, the first camera 120, and the controller 200, and may further include the communication part 140. The controller 200 includes the lighting provider 240, the object identifier 210, and the additional information provider 220.

The communication part 140 may access the Internet through a WiFi module. In this case, additional information provided by the additional information provider 220 may include information found in the Internet through the communication part 140. For example, the multimedia device may identify a product, find information about the product through the Internet, and provide the information.

According to an additional aspect, the multimedia device includes the main body 100, the projection part 110, the first camera 120, and the controller 200. Here, the controller 200 may include the lighting provider 240, the object identifier 210, the additional information provider 220, and may further include an action interface 250.

The action interface 250 may receive an image from the first camera 120, analyze an action of the user to determine a control command, and perform a preset corresponding function according to a result thereof.

The action interface 250 may be a program command set stored in a memory and may be executed by a processor. However, the action interface 250 is not limited thereto, and may also include a specific logic, a gate array, or a combination thereof.

When the user takes a preset gesture, the action interface 250 may identify the gesture, and determine whether the gesture is a preset interface gesture. When the gesture is the interface gesture, the action interface 250 may perform a corresponding control command to provide a corresponding function. For example, the action interface 250 may also identify an action of fingers and perform a command to expand or contract an additional information screen, turn a lighting device on or off using a gesture, and count the number of fingers to adjust brightness of light.

Some gestures corresponding to control commands may be set when the multimedia device is manufactured, and may be added while the user uses the multimedia device.

When the multimedia device according to another aspect is turned on, first, the lighting provider 240 controls an output of the projection part 110 to provide light. Next, the action interface 250 identifies an action of the user from a captured image, and determines whether the identified action is a set interface action to determine a control command. When the identified action corresponds to the control command, the action interface 250 performs a corresponding function.

According to an additional aspect, the multimedia device may include the main body 100, the projection part 110, the first camera 120, and the controller 200, and may further include an audio input part 150. Here, the controller 200 may include the lighting provider 240, the object identifier 210, and the additional information provider 220, and further include a voice interface 260.

The voice interface 260 may analyze voice of the user input through the audio input part 150 to determine a control command, and perform a set corresponding function according to a result thereof.

When the user says a preset command, the voice interface 260 identifies the command and determines whether the command is the preset command. When the command is the preset command, the voice interface 260 may perform a control command corresponding to the command to provide a corresponding function. For example, when the user says ‘ruler’ while writing on a note, an image of a ruler may be projected on a line of the note, and the user may turn a lighting device on or off through the voice.

Some of voice commands corresponding to control commands may be set when the multimedia device is manufactured, and may be added while the user uses the multimedia device.

When the multimedia device according to another aspect is turned on, first, the lighting provider 240 control an output of the projection part 110 to provide light. Next, the voice interface 260 identifies voice of the user from audio input through the audio input part 150, and determines whether the identified voice is a set interface command to determine a control command. When the voice corresponds to the control command, the corresponding function is performed.

According to an additional aspect, the multimedia device may include the main body 100, the projection part 110, the first camera 120, and the controller 200, and may further include the second camera 130. Here, the controller 200 may include the lighting provider 240, the object identifier 210, and the additional information provider 220, and may further include a sightline identifier 230.

The second camera 130 captures an image of the user or an action of the user and transmits the image to an input of the controller 200. The second camera 130 may be installed in a camera module type like the first camera 120. Accordingly, the second camera 130 may also mainly include an image sensor, a lens module, an IR filter, and the like.

The sightline identifier 230 may check information about eye positions, a head direction, and the like of the user, an angle between the eye positions of the user and an object of interest, and the like to determine a sight position. The sightline identifier 230 may be a command set stored in a memory and may be executed by a processor. However, the sightline identifier 230 is not limited thereto, and may also include a specific logic, a gate array, or a combination thereof.

When the multimedia device according to another aspect is turned on, first, the lighting provider 240 controls an output of the projection part 110 to provide light.

Next, the sightline identifier 230 analyzes images input by the first camera 120 and the second camera 130, and tracks a sight direction of the user to determine a sight position. The object identifier 210 specifies an object of interest among objects placed at the sight position. The object identifier 210 identifies the specified object of interest and transmits the identified information to the additional information provider 220. The additional information provider 220 searches for additional information about the identified object and controls the projection part 110 to project the additional information.

According to another aspect, the additional information provider 220 may provide additional information about an identified object of interest at a position derived from a position of an object of interest. That is, the additional information provider 220 determines a position to which the projection part 110 projects additional information in consideration of a size and a position of the identified object of interest. A method of determining the position may be a method in which an area which is a widest area around an object of interest is determined as the position, a method in which an area placed in a specific direction with respect to an object of interest is determined as the position, or the like. For example, when an object of interest is placed on the right of an area captured by the first camera 120, a left area of the object of interest may be determined as a position to which additional information is projected.

According to another aspect, the additional information provider 220 may provide additional information about an identified object of interest at a position derived from a tracked sight position. That is, the additional information provider 220 determines a position to which the projection part 110 projects additional information in consideration of a sight position. A method of determining the position may be a method in which a position which is widest area around the sight position is determined as the position, a method in which a position place in a specific direction with respect to the sight position is determined as the position, or the like. However, the method is not limited thereto.

According to another aspect, an object of interest specified and identified by the object identifier 210 may be information printed on an object. For example, when an object of interest is a book and information printed on the book is a name of a specific person, an image of additional information about the person may be projected.

According to another aspect, the lighting provider 240 may control an output of the projection part 110 to provide light for a sight position tracked by the sightline identifier 230. In this case, the multimedia device may be used as only a lighting device without providing additional information, or may be used as a lighting device while information is displayed at a part of an output of the lighting device, that is, at a partial area, and the remaining part thereof may be used for projecting light.

When the multimedia device according to another aspect is turned on, first, the lighting provider 240 controls an output of the projection part 110 to provide light. Next, the sightline identifier 230 analyzes images input by the first camera 120 and the second camera 130, and tracks a sight direction of the user to determine a sight position of the user. The lighting provider 240 controls the projection part 110 to provide light for the determined sight position.

According to an additional aspect, the multimedia device includes the main body 100, the projection part 110, the first camera 120, the controller 200, and the second camera 130, and may further includes the communication part 140. Here, the controller 200 may include the lighting provider 240, the object identifier 210, the additional information provider 220, and the sightline identifier 230.

The communication part 140 accesses the Internet through a WiFi module. In this case, additional information provided by the additional information provider 220 may include information found by browsing the Internet using the communication part 140. For example, the multimedia device may identify a product and obtain information about the product by browsing the Internet to provide the information.

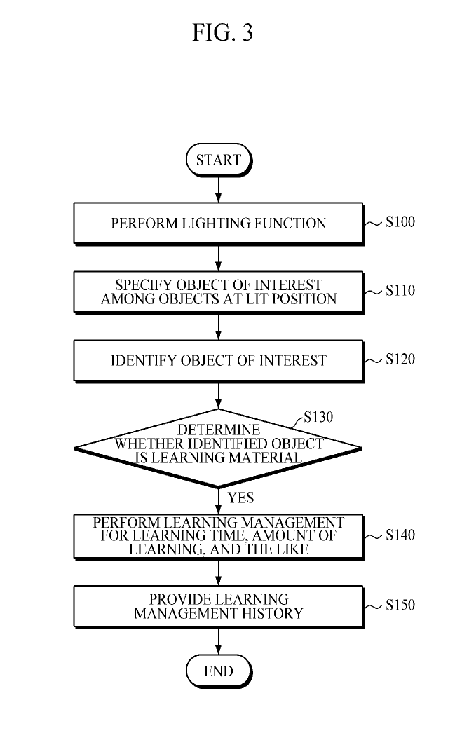

FIG. 3 is a flowchart illustrating a learning management process of a multimedia device according to another embodiment. According to an additional aspect, the multimedia device includes a main body 100, a projection part 110, a first camera 120, and a controller 200. Here, the controller 200 may include a lighting provider 240, an object identifier 210, an additional information provider 220, and may further include a learning manager 270.

When an object of interest identified by the object identifier 210 is identified as a learning material, the learning manager 270 may perform learning management including learning time management and learning progress management related to the identified learning material.

That is, when an identified object of interest corresponds to a learning material of a specific subject, the learning manager 270 may perform management related to learning date, time, pages, and a progress check for a learning amount of a corresponding subject, and the like.

In addition, when a learning material is identified as an object of interest, additional information about a learning management history of the corresponding learning material may be checked through the projection part 110.

The learning manager 270 may be a program command set stored in a memory and may be executed by a processor. However, the learning manager 270 is not limited thereto, and may also include a specific logic, a gate array, or a combination thereof.

As illustrated in FIG. 3, when the multimedia device is turned on, first, the lighting provider 240 controls an output of the projection part 110 to provide light (S100). Next, the first camera 120 captures images at a lit position, and the object identifier 210 specifies an object of interest among objects in the captured images (S110). The object identifier 210 identifies the specified object of interest (S120), and determines whether the identified object of interest corresponds to a learning material (S130). When it is determined that the identified object of interest corresponds to the learning material, the learning manager 270 performs management related to learning date, time, pages, and a progress check for a learning amount of a corresponding subject (S140). The user may selectively project a learning management history of the corresponding learning material through the projection part 110 and may be provided with the learning management history as additional information (S150).

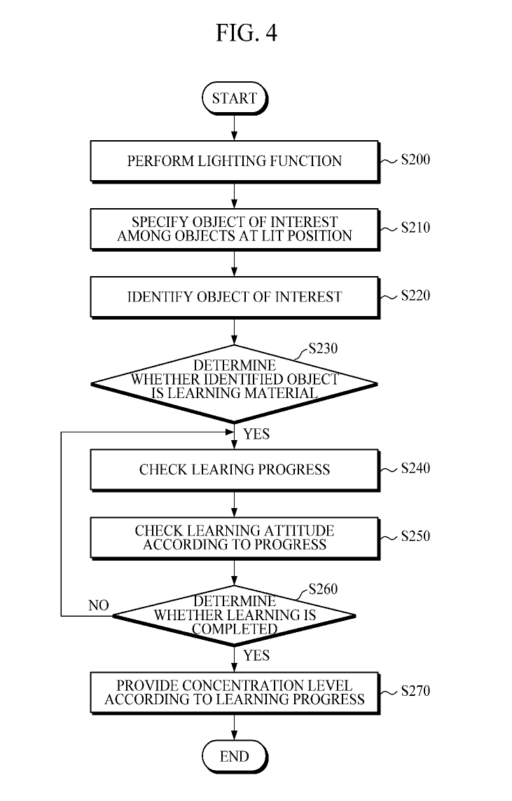

FIG. 4 is a flowchart illustrating a learning concentration management process of the multimedia device according to another embodiment. According to an additional aspect, the multimedia device includes the main body 100, the projection part 110, the first camera 120, and the controller 200, and may further include a second camera 130. The controller 200 may include the lighting provider 240, the object identifier 210, and the additional information provider 220, and may further include the learning manager 270.

When it is identified that the user is learning, the learning manager 270 may identify movement of pupils and a neck to detect dozing during the learning, and check and manage a concentration level according to learning progress.

Particularly, the learning manager 270 may check a portion at which the user dozes during the learning so as to reflect the portion on the concentration level according to the learning progress, and later, the user may check additional information about the learning material.

According to another aspect, in a case in which dozing is detected, the learning manager 270 may adjust a warning alarm or brightness of light to remind the user.

As illustrated in FIG. 4, when the multimedia device is turned on, first, the lighting provider 240 controls an output of the projection part 110 to provide light (S200). Next, the first camera 120 captures images at a lit position, and object identifier 210 specifies an object of interest among objects in the captured images (S210). The object identifier 210 identifies the specified object of interest (S220) and determines whether the identified object of interest corresponds to a learning material (S230). When it is determined that the identified object of interest corresponds to the learning material, the learning manager 270 checks a learning progress of a corresponding subject (S240). The learning manager 270 analyzes movements of eyes, a head, and the like of the user from the images captured by the first camera 120 and the second camera 130 to check a learning attitude (S250). The learning manager 270 determines whether the user has stopped the learning (S260), and when the user has not stopped the learning, the learning manager 270 continuously checks a learning progress and a learning attitude according to the progress. When the learning is completed, concentration level information according to the learning progress related to the corresponding learning material may be projected through the projection part 110 and provided as additional information (S270).

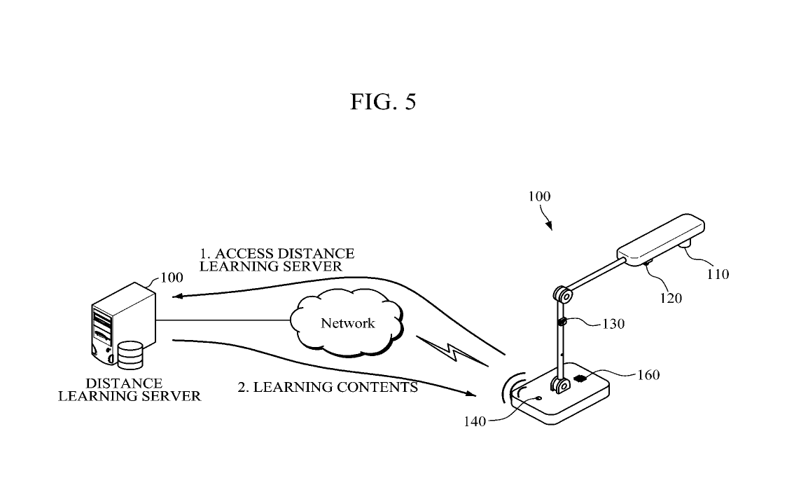

FIG. 5 is a brief conceptual view about a distance learning function of the multimedia device according to another embodiment. According to an additional aspect, the multimedia device may include the main body 100, the projection part 110, the first camera 120, and the controller 200, and may further include the communication part 140 and an audio output part 160. Here, the controller 200 may include the lighting provider 240, the object identifier 210, and the additional information provider 220, and may further include a distance learning part 280.

The communication part 140 includes a WiFi module to access the Internet. The communication part 140 accesses a distance learning server to receive learning contents.

The audio output part 160 may be an embedded speaker embedded in the main body 100 or an external speaker installed separately from the main body 100.

The distance learning part 280 may be provided with customized learning contents from the distance learning server according to contents and a progress of a learning material which is an identified object of interest and may provide the contents at a position, which is derived from a position of the learning material, through the projection part 110. Here, the learning contents may be contents downloaded or streamed from the distance learning server.

The distance learning part 280 may be a program command set stored in a memory and may be executed by a processor. However, the distance learning part 280 is not limited thereto, and may also include a specific logic, a gate array, or a combination thereof.

A progress related to a learning material may be checked through the learning manager 270. According to another aspect, the learning manager 270 may identify a learning attitude during a distance learning and check and manage a concentration level according to a learning progress.

When the multimedia device according to another aspect is turned on, first, the lighting provider 240 controls an output of the projection part 110 to provide light. Next, the first camera 120 captures images at a lit position, and the object identifier 210 specifies an object of interest among objects in the captured images to identify the specified object of interest, and determines whether the identified object of interest corresponds to a learning material. When it is determined that the identified object of interest is the learning material, the learning manager 270 checks a learning progress of a corresponding subject. The learning manager 270 accesses the distance learning server through the communication part 140. The learning manager 270 receives customized learning contents from the distance learning server according to the learning progress and provides the contents at a position derived from a position of the learning material through the projection part 110.

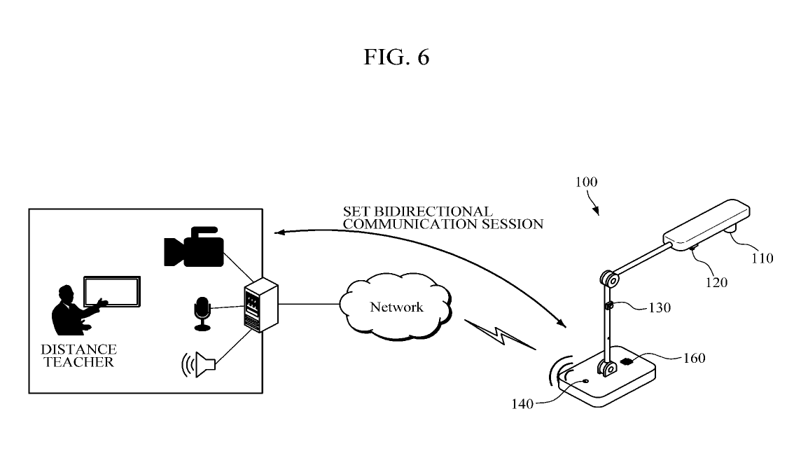

FIG. 6 is a brief conceptual view about a bidirectional distance learning function of the multimedia device according to another embodiment. According to an additional aspect, the multimedia device may include the main body 100, the projection part 110, the first camera 120, and the controller 200, and may further include the communication part 140, the audio output part 160, and an audio input part 150. Here, the controller 200 may include the lighting provider 240, the object identifier 210, and the additional information provider 220, and may further include the distance learning part 280.

The distance learning part 280 may bidirectionally communicate with a distance teacher through the communication part 140. For example, the distance learning part 280 may bidirectionally communicate with a server capable of transmitting a lecture of the distance teacher, and the distance teacher may also bidirectionally communicate with a corresponding device in a case in which the distance teacher possesses the multimedia device according to the present invention.

A standard protocol used for a voice over Internet protocol (VoIP) may be used as a protocol used in the bidirectional communication. For example, a session initiation protocol (SIP) may be used for connecting bidirectional communication sessions, and a real-time transport protocol/real-time transport protocol control protocol (RTP/RTCP) may be used for transmitting voice and image data. However, the protocol is not limited thereto, and the bidirectional communication may also be provided through a non-standard communication protocol determined between a learner and a teacher for a distance learning.

The user may remotely receive learning guidance from a distance teacher through connected bidirectional communication sessions. Here, a lecture image is projected through the projection part 110, and a lecture voice is output through the audio output part 160. In addition, the user may question about lecture contents to the distance teacher through the audio input part 150.

When the multimedia device according to another aspect is turned on, first, the lighting provider 240 controls an output of the projection part 110 to provide light. Next, the first camera 120 captures images at a lit position, and the object identifier 210 specifies an object of interest among objects in the captured images. The object identifier 210 identifies the specified object of interest and determines whether the identified object of interest corresponds to a learning material. The distance learning part 280 tries to bidirectionally communicate with a distance teacher through the communication part 140. When there is a response from the distance teacher, bidirectional communication is set. The user is provided with learning contents of a distance lecture from the distance teacher. Here, the learning contents may be projected at a position derived from a position of the learning material through the projection part 110.

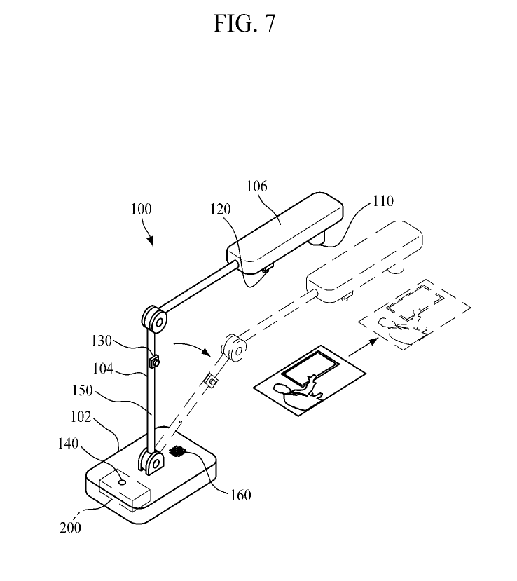

FIG. 7 is a brief conceptual view related to an actuator 170 of the multimedia device according to another aspect. According to another aspect, the multimedia device may include the main body 100, the projection part 110, the first camera 120, and the controller 200, and may further include the second camera 130 and the actuators 170. Here, the controller 200 may include the lighting provider 240, the object identifier 210, and the additional information provider 220, and may further include a sightline identifier 230 and an actuator controller 290.

The actuator 170 may be installed at a position at which the base 102 is connected to the support 104 or a position at which the support 104 is connected to the header 106, and may rotate in three axial directions. Since a technology of an actuator is a known technology, a detailed description thereof will be omitted.

The actuators 170 may rotate the header 106 in forward, backward, leftward, and rightward directions, and may be used to change a position, at which additional information is displayed or light is emitted, to a wide area, and particularly expand an object identification range.

The actuator controller 290 controls the actuator 170 according to a position derived from a position of an object of interest. That is, when a position and an angle of the header 106 need to be changed for providing additional information at the position derived from the position of the object, the actuator controller 290 drives the actuator 170 to change the position and the angle of the header 106.

The actuator controller 290 may be a program command set stored in a memory and may be executed by a processor. However, the actuator controller 290 is not limited thereto, and may also include a specific logic, a gate array, or a combination thereof.

According to another aspect, the actuator controller 290 controls the actuator 170 according to a position derived from a tracked sight position. That is, when a position and an angle of the header 106 need to be changed for providing additional information at the position derived from a sight position, the actuator controller 290 may drive the actuator 170 to change the position and the angle of the header 106.

As described above, the present invention can provide additional information about an identified object.

The present invention can also provide additional information about characters printed on an identified object to utilize the additional information in a learning activity.

Since the present invention can also track a sight direction of a user, an identifiable range can be expanded.

The present invention can also analyze and manage a learning attitude and a concentration level, support distance learning, and thus be utilized in a learning activity.

While the embodiments have been described with reference to the accompanying drawings, the embodiments are not limited thereto, and should be interpreted to cover various modified embodiments which may be made clearly by those skilled in the art. The claims have been intended to cover the modified embodiments.

1. A lighting stand type multimedia device comprising:
a main body including a base, a support fixed to the base, and a header fixed to an upper portion of the support;
a projection part installed at the header of the main body;
a first camera installed in the main body; and
a controller including a lighting provider positioned inside the main body and configured to provide light through the projection part, an object identifier configured to specify and identify an object of interest among objects captured by the first camera, and an additional information provider configured to provide additional information about the identified object of interest through the projection part.

2. The lighting stand type multimedia device of claim 1, further comprising a second camera installed in the main body, wherein:
the controller further includes a sightline identifier configured to track a sight direction of a user by using the first camera and the second camera;
the object identifier specifies and identifies an object placed in a tracked sight direction as an object of interest; and
the additional information provider provides additional information about the identified object of interest through the projection part.

3. The lighting stand type multimedia device of claim 1, wherein the additional information provider provides the additional information about the identified object of interest to a position derived from a position of the object of interest.

4. The lighting stand type multimedia device of claim 2, wherein the additional information provider provides the additional information about the identified object of interest to a position derived from a tracked sight position.

5. The lighting stand type multimedia device of claim 1, further comprising a communication part disposed inside the main body and configured to perform communication through a network,
wherein the additional information provider has information obtained by browsing the Internet using the communication part.

6. The lighting stand type multimedia device of claim 3, further comprising a communication part disposed inside the main body and configured to perform communication through a network,
wherein the additional information provider has information obtained by browsing the Internet using the communication part.

7. The lighting stand type multimedia device of claim 1, wherein the object of interest specified and identified by the object identifier includes information printed on the object.

8. The lighting stand type multimedia device of claim 2, wherein the lighting provider controls an output of the projection part to provide light for a tracked sight position.

9. The lighting stand type multimedia device of claim 1, wherein the controller further includes an action interface configured to receive an image from the first camera, analyze an action of a user to determine whether the action is a control command, and perform a set corresponding function according to a result of the determination.

10. The lighting stand type multimedia device of claim 1, further comprising an audio input part inside the main body,
wherein the controller further includes a voice interface configured to analyze a voice of a user to determine whether the voice is a control command, and perform a set corresponding function according to a result of the determination.

11. The lighting stand type multimedia device of claim 1, wherein the controller further includes a learning manager configured to perform learning management including learning time management and learning progress management related to the identified learning material when the object of interest identified by the object identifier is identified as a learning material.

12. The lighting stand type multimedia device of claim 11, further comprising a second camera installed in the main body,
wherein the learning manager identifies and analyzes a learning attitude of a user and checks and manages a concentration level according to a learning progress while performing the learning management.

13. The lighting stand type multimedia device of claim 11, further comprising:
a communication part disposed inside the main body and configured to perform communication through a network; and
an audio output part embedded in or installed outside the main body,
wherein the controller further includes a distance learning part configured to receive customized learning contents from a distance server according to contents and a progress of a learning material which is the identified object of interest and provide the contents to a position derived from a position of the learning material through the projection part.

14. The lighting stand type multimedia device of claim 13, further comprising an audio input part installed in the main body,
wherein the distance learning part bidirectionally communicates with a distance teacher to provide a distance learning.

15. The lighting stand type multimedia device of claim 3, further comprising a three-axial actuator installed at one position at which the base is connected to a support or the support is connected to the header and configured to rotate in three axial directions,
wherein the controller further includes an actuator controller configured to control the three-axial actuator according to a position derived from a position of an object of interest.

16. The lighting stand type multimedia device of claim 4, further comprising a three-axial actuator installed at one position at which the base is connected to a support or the support is connected to the header and configured to rotate in three axial directions,
wherein the controller further includes an actuator controller configured to control the three-axial actuator according to a position derived from the tracked sight position.
